(19) United States
(12) Patent Application Publication
(10) Pub. No.: US 2014/0028427 A1
(43) Pub. Date: Jan. 30, 2014

(54) DRY DISTRIBUTION TRANSFORMER

(71) Applicant: Martin Alsina Navarro, Jundiai (BR)

(72) Inventor: Martin Alsina Navarro, Jundiai (BR)

(73) Assignee: Siemens Ltda., Sao Paulo (BR)

(21) Appl. No.: 13/983,027

(22) PCT Filed: Feb. 1, 2012
(86) PCT No.: PCT/BR2012/000019

§ 371 Date: Oct. 11, 2013

(30) Foreign Application Priority Data
Feb. 2, 2011 (BR) PI1100186-0

(51) Int. Cl. H01F 27/16; H01F 27/32

(52) U.S. Cl. CPC H01F 27/16; H01F 27/32
USPC 336/61

(57) ABSTRACT

The present invention relates to a dry distribution transformer (1) comprising at least one low-voltage winding (2) and one high-voltage winding (3), concentrically mounted around a core column (1.1, 1.3). The transformer (1) comprises at least one cooling circuit (7) associated to at least one low-voltage winding (2) and/or one high-voltage winding (3). Such a cooling circuit (7) is electrically insulated with respect to the low-voltage and high-voltage windings (2, 3). In addition, the cooling circuit (7) is capable of enabling circulation of a cooling fluid inside it. Additionally, the cooling circuit (7) is provided with a constructive arrangement configured to involve partly the core column (1.2, 1.3), that is, the constructive arrangement is configured not to form a turn around the core column (1.1, 1.3). The cooling circuit (7) is provided with cooling ducts (6), each cooling duct (6) having a cross section that partly involves a cross section of the core column (1.2, 1.3).

This application claims priority of Brazilian Patent Application No. PI1100186-0, filed on Feb. 2, 2011, its disclosure being hereby incorporated by reference.

The present invention relates to a dry distribution transformer. More particularly, the present invention relates to a three-phase or single-phase dry-distribution electric transformer, provided with solid insulation and designed for use preferably on industrial distribution installations, oil-exploitation or marine platform.

### DESCRIPTION OF THE PRIOR ART

As it is known from the prior art, electric energy distribution systems use electric transformers capable of enabling the supply of electric energy in voltages suitable for conducting electric current from the generation places to the consumption regions.

Particularly, for the transmission of electric energy along long distances to be possible, it is common practice to raise the generating voltage through transformers, so as to reduce the effects of power losses that take place on the electric resistance of the conducting cables. Thus, the transmission of electric energy is made at a high voltage as far as close to the consumption regions, where this voltage is then reduced to values suitable for the pieces of equipment of the users, also by means of transformers. Such reduction in the voltage level is carried out in various steps, by using transformers that are located close to the energy-consumption centers, and the physical installation may be suspended, fixed to posts, on the ground at an internal or external installation, or still at an underground installation.

In general, an electric transformer is constituted basically by high-voltage windings, low-voltage windings, iron core for circulation of the magnetic flux, connections between the windings and connection terminals. In view of losses, the windings and cores exhibit an increase in temperature, the maximum heating permitted being determined by the material and rules.

Typically, at industrial installations like, for example, oil drilling platforms or vessels, where the space for installation is small, dry transformers with solid insulation are used. In other words, at these types of installations one uses transformers, the active part of which being immersed into an insulating liquid, which have one or more windings encapsulated in solid insulation. The preferably used voltages are on the order of 4,160 V, 13,800 V for high-voltage windings and 220 V, 380 V, 660 V for low-voltage windings. The usually employed powers are on the order of 300 kVA to a few dozens of MVA.

Such transformers with solid insulation can be either air-cooled or with natural or forced circulation, or through air/water heat-exchangers. The rules like, for example, Brazilian Norm NBR 10295, designate cooling with natural or air circulation by “AN” when the transmission of heat from the windings to air is carried by means of air in a natural or spontaneous manner. In this case, the air heated by the heat lost from the transformer windings is replaced by surrounding air at a lower temperature, providing a natural air circulation.

It should be noted that the capacity of the windings to transmit heat to air depends on various factors, among which are the temperature of the air, the temperature of the windings, the relative humidity of the air, the atmospheric pressure and transformer installation height. An alternative to increase the capacity of the coils to transmit heat to the air is by forced ventilation or forced air (identified as “AF” by the rules) by using fans, for instance.

For example, FIG. 1 shows a dry transformer 1′ with forced-air cooling “AF”, as known at present. A fan 11′ promotes withdrawal of hot air from the upper part of the transformer and conducts it to a heat exchanger 12′, which in turn causes cooled air to return to the bottom of the transformer 1′. The cooled air receives heat from the transformer 1′ and rises to the top so as to repeat the cycle (the arrows in the drawing indicate the air motion direction). However, this cooling technique has the disadvantage that the heat exchange in the transformer 1′ is made by means of air having less effective absorption capacity with respect to water. Besides, another disadvantage of this technique lies in the fact that the heat exchanger is positioned close to the transformer, which is a drawback at installations having reduced space, like oil platform or vessels.

Alternatively, the dry transformers may also be water-cooled, with water circulating inside the winding conduit itself. An example of this type of transformer is shown in Chinese patent CN 201340871.I

However, considering that this cooling water is in contact with the winding conduit, thus being subject to the same electric voltage, electric insulation is required. Thus, the water-cooled dry transformers known so far require cooling water to be subjected to a deionization process and treatment, in order to be electrically insulating or little conductive (high value of electric resistance of water), in order to prevent short-circuits with the other parts of the transformers.

In addition, the cooling-water deionization equipment is expensive and require intensive maintenance, which means a significant increase in cost.

Additionally, the water-cooled dry transformers according to the present-day technology need insulating ducts for interconnecting the hollow conduits of the transformer winding under voltage top the deionization and water-cooling systems, which also increases the maintenance cost due to the constant risk of cooling-water leakage.

Further, the ducts that conduct water between the windings and the deionization and water-cooling systems should be insulated together with the winding until there is sufficient space for the duct resistance and water to be sufficiently high to prevent short-circuits. This embodiment requires a careful work of mounting the connections between ducts and installation spaces, which also increases costs.

Optionally, a few techniques are already known, for example, those described in patent cases CN 2785106 and WO 98/34241, which describe dry transformers cooled by a water circuit separated from the coil windings. However, the transformers shown in these prior-art documents have cooling means that are configured in such a way, that they cause electromagnetic losses, which is naturally undesirable, since this impairs the efficiency thereof.

### OBJECTIVES OF THE INVENTION

The objectives of the present invention consist in providing a low-cost dry distribution transformer having cooling means that use a cooling fluid capable of reducing the temperature of said transformer in a safe and efficient manner.

Besides, the objectives of the present invention also consist in providing a dry power transformer capable of providing its own cooling without causing increase in the electromagnetic losses and thus optimizing the operation efficiency.

Additionally, the objectives of the present invention further consist in providing a compact, low-cost electric transformer, capable of providing its own self-cooling.

### BRIEF DESCRIPTION OF THE INVENTION

One or more objectives of the present invention is (are) achieved by providing a dry distribution transformer comprising at least one low-voltage winding and one high-voltage winding concentrically mounted around a core column. Said transformer comprises at least one cooling circuit associated to at least one low-voltage and/or high-voltage winding. Such a cooling circuit is electrically insulated from the low-voltage and high-voltage windings. Besides, the cooling circuit is capable of enabling circulation of a cooling fluid inside it. Additionally, the cooling circuit is provided with a constructive arrangement configured for partly involving the core column.

In other words, the constructive arrangement of the cooling circuit is configured to form coil around the core column.

One or more objectives of the present invention is (are) also achieved by providing a dry distribution transformer comprising a dry distribution transformer comprising at least one low-voltage winding and one high-voltage winding concentrically mounted around a core column. Said transformer comprises at least one cooling circuit associated to at least one low-voltage and/or high-voltage winding. Such a cooling circuit is electrically insulated from the low-voltage and high-voltage windings. Besides, the cooling circuit is capable of enabling circulation of a cooling fluid inside it. Additionally, the cooling circuit is provided with cooling ducts, each cooling duct having a cross section that partly involves a cross section of the core column.

### BRIEF DESCRIPTION OF THE DRAWINGS

The present invention will now be described in greater detail with reference to the attached drawings, in which:

FIG. 1 represents a perspective view of a dry distribution transformer provided with forced-air and forced-water cooling means, through a heat exchanger, as known from the prior art;

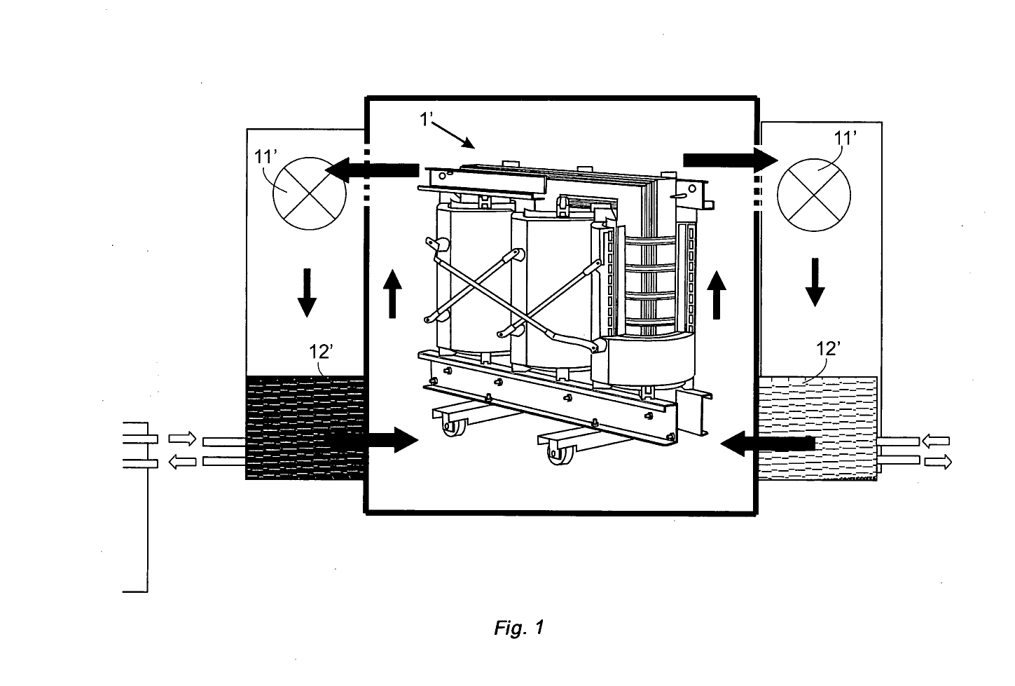

FIG. 2 represents a perspective view of a dry distribution transformer according to a preferred embodiment of the present invention;

FIG. 3 represents a schematic side view of the dry distribution transformer shown in FIG. 2;

FIG. 4 represents a schematic top view of the dry distribution transformer shown in FIG. 2, pointing out the constructive arrangement of the cooling ducts;

FIG. 5 represents a schematic side view of a high-voltage winding section of the dry distribution transformer shown in FIG. 2, associated to the cooling ducts;

FIG. 6 represents a first embodiment of the cooling ducts of the dry distribution transformer shown in FIG. 2;

FIG. 7 represents a second embodiment of the cooling ducts of the dry distribution transformer shown in FIG. 2; and

FIG. 8 represents a schematic side view of a high-voltage winding section and a low-voltage winding section of the dry distribution transformer shown in FIG. 2, associated to the cooling ducts.

### DETAILED DESCRIPTION OF THE FIGURES

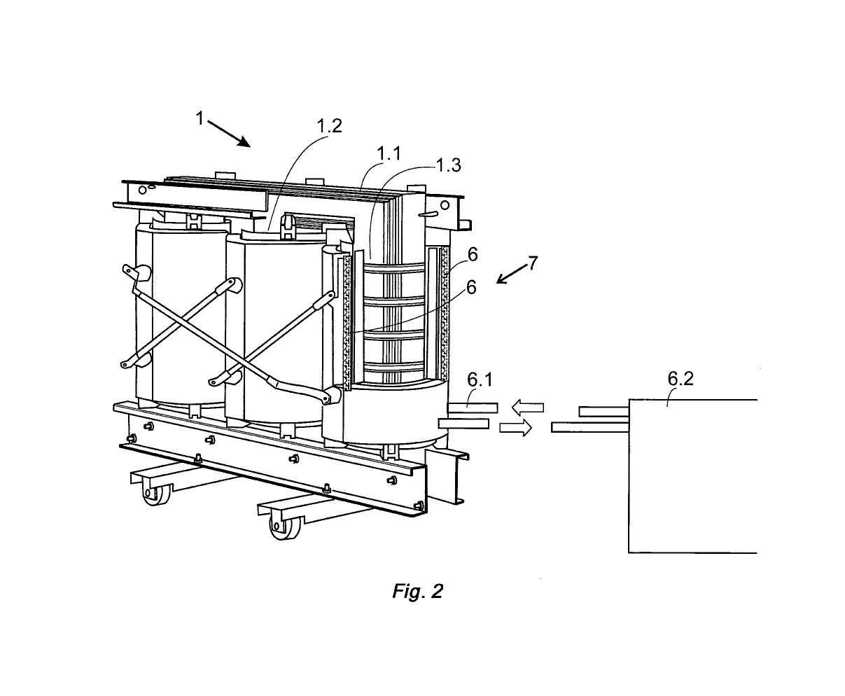

FIG. 2 shows a perspective view of a dry distribution transformer 1 according to a preferred embodiment of the present invention, preferably for use at industrial distribution installations, oil exploitation platforms or marinas. For this reason, the transformer 1 is capable of providing powers of up to a few dozens of thousands of KVA.

Initially, it should be pointed out that the technique of the present invention can be applied to both a three-phase transformer and a single-phase transformer.

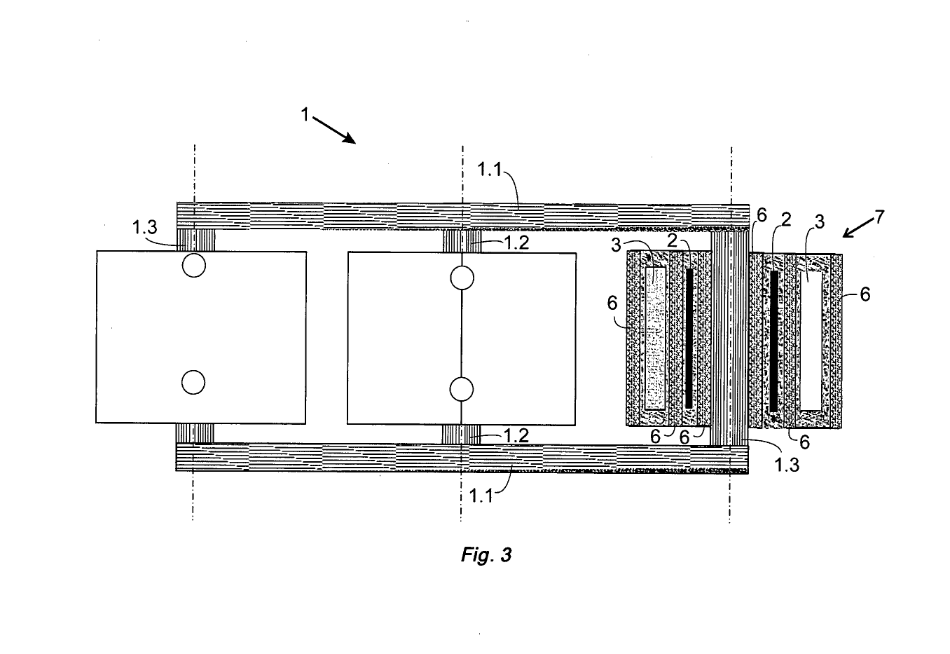

As can be observed in FIG. 3, such a dry distribution transformer 1 comprises at least one low-voltage winding (or coil) and one high-voltage winding (or coil), mounted concentrically around a core column 1.2, 1.3, where the low-voltage and high-voltage windings 2, 3 are electrically insulated from each other through a solid material. Particularly, in the preferred embodiment of the present invention, the transformer 1 is of the three-phase type and comprises a three-phase core 1.1, 1.2, 1.3, there low-voltage windings 2 and three high-voltage windings 3, as can be seen in FIGS. 2, 3, and 4. More specifically, said core comprises upper and lower portions or core columns 1.1, central core columns 1.2 and side core columns 1.3.

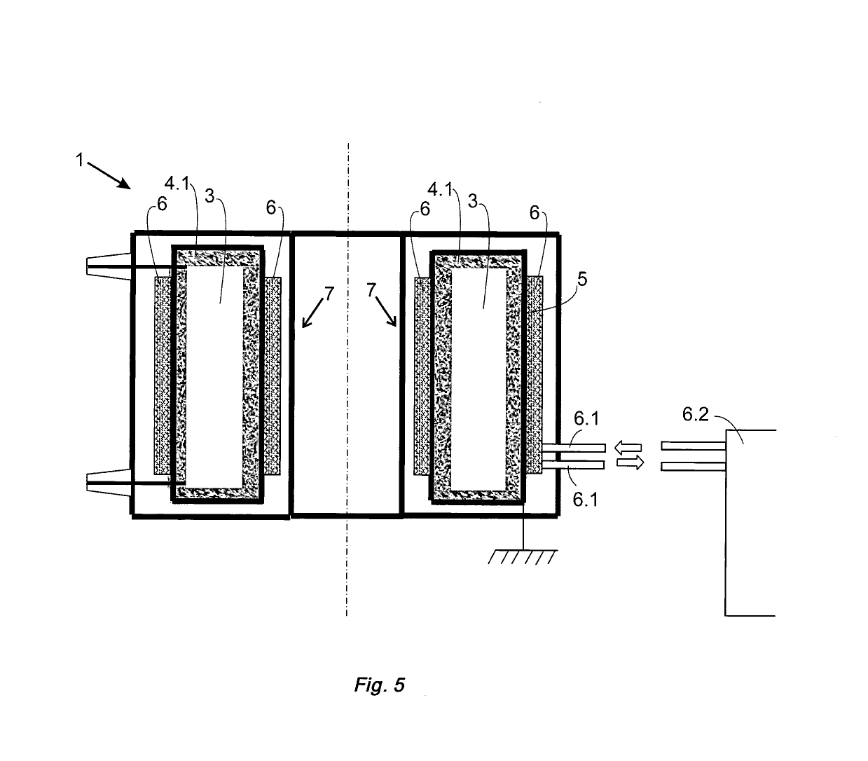

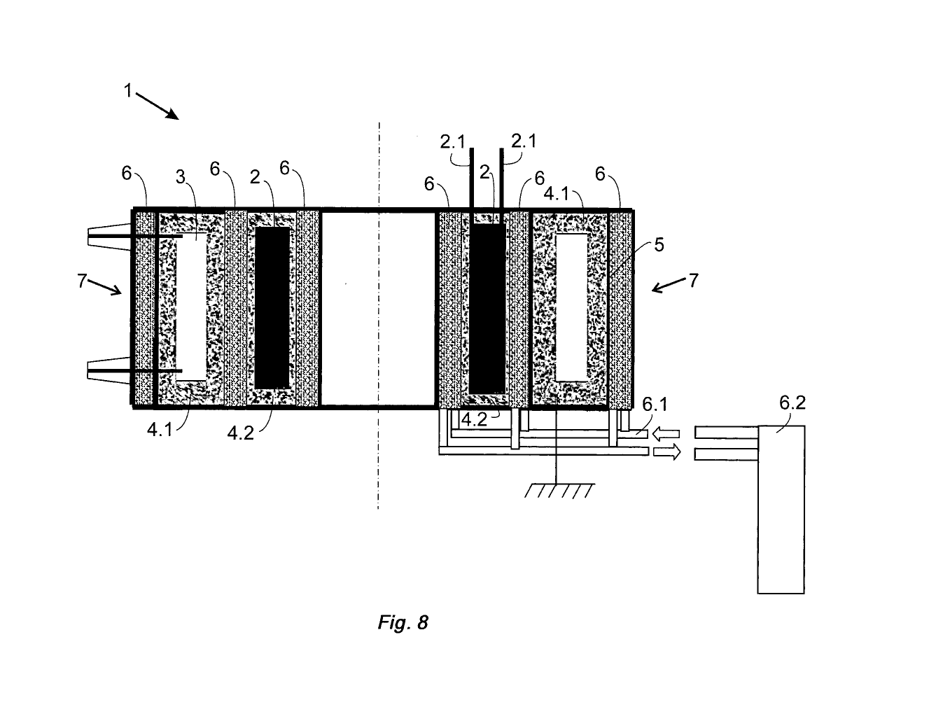

As can be observed in FIGS. 5 and 8, the high-voltage winding 3, called also outer winding, is insulated from the ground by means of a first solid insulation 4.1, for example, epoxy resin. On the outside of the first solid insulation 4.1, it is common practice to provide an electrostatic shielding 5, grounded for field standardization. The low-voltage winding 2, called also inner winding, is insulated from the ground by means of a second solid insulation 4.2, for example epoxy resin. The low-voltage winding 2 may have grounded or non-grounded shielding, according to the characteristics of the insulation.

Further according to FIG. 8, the transformer 1 comprises terminals 2.1 of low-voltage winding 2, which are encapsulated, shielded and mounted on top of the winding. Preferably, such terminals 2.1 are of the plug-in type, disconnectable.

Additionally, the transformer 1 comprises at least one cooling circuit 7, associated to at least one low-voltage winding 2 or to a high-voltage winding 3, capable of enabling circulation of a cooling fluid inside it. It should be noted that this association between the cooling circuit 7 to the high-voltage or low-voltage windings 2, 3 is made so as to guarantee electric insulation between them, that is, the cooling circuit 7 is electrically insulated with respect to the low-voltage and high-voltage windings 2,3. Besides, the cooling circuit 7 is also preferably grounded.

Preferably, the cooling fluid consists of sea water in applications where the transformer is used at installations like oil-exploitation platforms or vessels. Of course, other types of fluids may be used, as long as they are suitable for the desired application, as for example, fresh water, recycled water or even water already used on other industrial-cooling equipment, including the addition of charges of any nature to raise the thermal conductivity of the cooling water.

Still preferably, the cooling fluid circulates in a forced manner inside the cooling circuit 7. Thus, the cooling fluid absorbs the heat from the windings of the transformer 1 and, after circulating through the parts (ducts) of the cooling circuit 7 close to the windings, it is removed, which enables the entry of cooling fluid at a lower temperature.

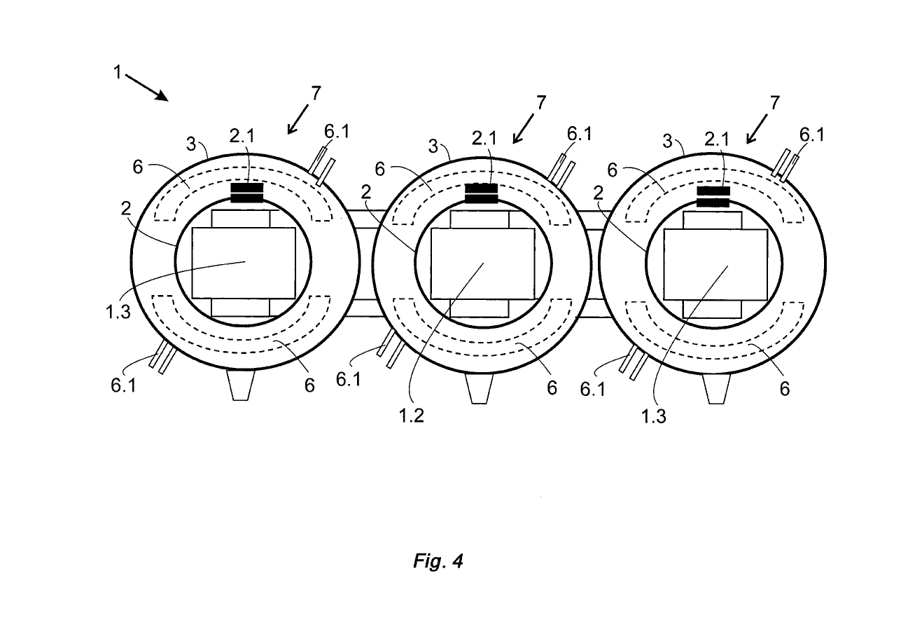

It should be further noted that the cooling circuit 7 is provided with a constructive arrangement configured to involve, in part, the core column 1.2, 1.3, as can be observed in FIG. 4. In other words, the cooling circuit 7 is provided with a constructive arrangement configured not to form a turn around the core column 1.2, 1.3, which enables one to reduce the electromagnetic losses, thus providing optimization of the operation efficiency.

First, the cooling circuit 7 comprises at least one cooling duct 6, which involves, partly or wholly, the low-voltage winding 2 and/or the high-voltage winding 3, as can be seen in FIGS. 2, 3, 4, 5, and 8.

According to FIGS. 3, 4, 5 and 8, the cooling circuit 7 is provided with a plurality of cooling ducts 6 arranged in spaces comprised between the low-voltage winding 2 and the high-voltage winding 3. Preferably, the cooling ducts 6 are also arranged between the core column 1.2, 1.3 and the low-voltage and high-voltage windings 2, 3, in order to provide greater cooling efficacy.

Further preferably, the cooling ducts 6 are constituted by metallic materials, which should be grounded. Optionally, the cooling ducts 6 may be constituted by insulating resin or fiberglass materials, preferably grounded. In other words, the cooling ducts are constituted by a material suitable for the type of water used, for protection against corrosion, as for example, stainless steel or naval brass, or other materials that can or cannot be electrically conductive.

As can be seen in FIG. 4, each cooling duct 6 has a cross section that partly involves a cross section of the core column 1.2, 1.3. This constructive arrangement prevents the formation of a turn around the core column 1.2, 1.3.

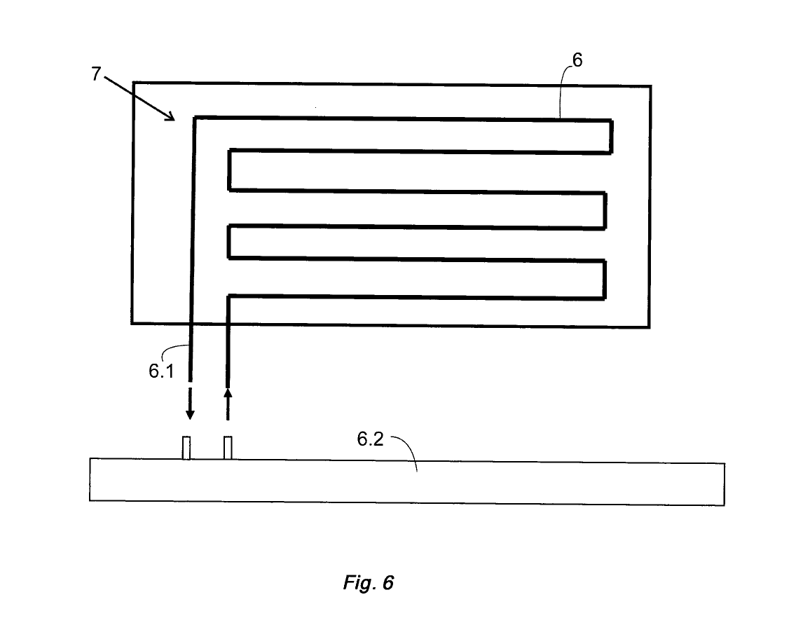

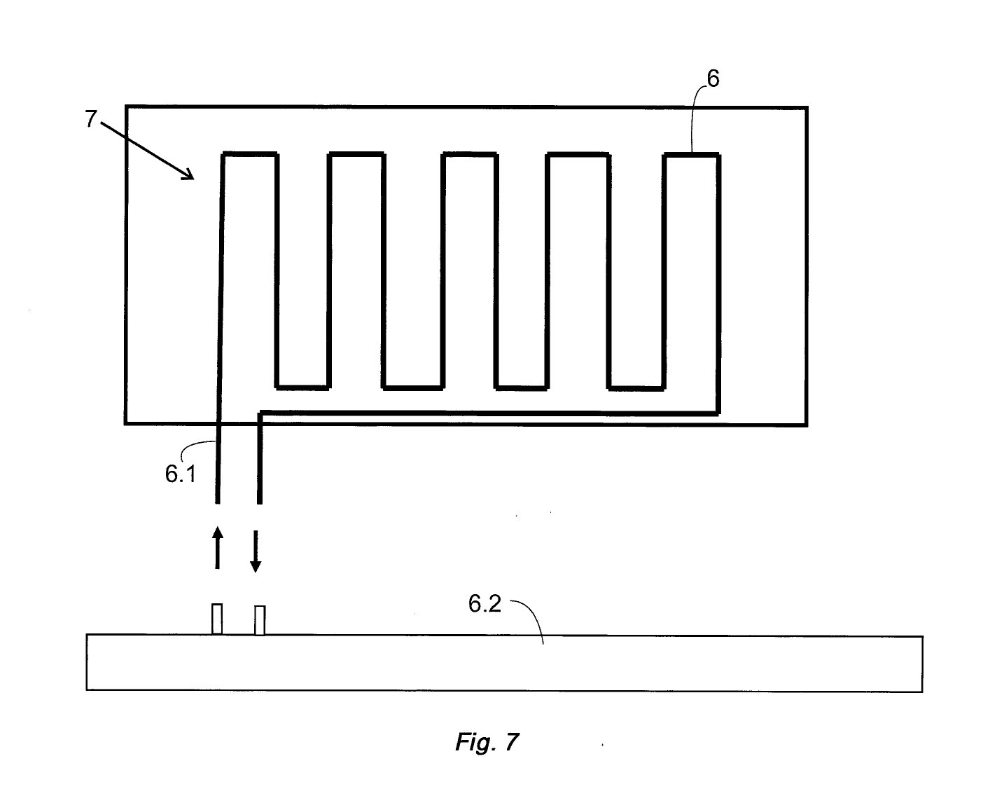

According to FIGS. 6 and 7, the cooling ducts 6 are operatively associated to an external heat exchanger 6.2 by means of input/output ducts 6.1. Such external heat exchanger 6.2 may be located at a convenient place, away from the transformer 1.

Thus, unlike the known techniques, the cooling ducts 6 of the present invention are insulated from the windings, grounded and prevent the formation of turn so as to enable the machine to operate with cooling by seawater or untreated water, at powers on the order of 50 MVA, and voltage class on the order of up to 34 kV. Because of this, it is possible to install the transformer 1 in a small space, since there is no need to allocate an internal space for treatment of the electric conductivity of the water and, besides, there is no need for a cubicle for the transformer 1. In other words, the transformer 1 of the present invention has the advantage of not needing a water-deionization system, which means reduction of cost and saving of material and space at the installation.

An additional advantage of the transformer 1 of the present invention refers to the fact that this transformer is free from insulating oils, which might contaminate the environment, as for instance the water table in the event of leakage, during the transportation or operation of the transformer. Thus, the installations of the transformers proposed in the present invention may be simple and economical to carry out, since the latter do not require oil-holding systems, in the event of leakage or explosion.

Additionally, in the transformer 1 of the invention, the transmission of heat from the windings to the cooling means is made by thermal conduction, which has greater thermal efficiency than the convection used in cooling by air.

A preferred embodiment having been described, one should understand that the scope of the present invention embraces other possible variations, being limited only by the contents of the accompanying claims, which include the possible equivalents.

1. A dry distribution transformer (1) comprising at least:
one low-voltage winding (2) and one high-voltage winding (3), concentrically mounted around a core column (1.2, 1.3) and
a cooling circuit (7) associated to at least one low-voltage winding (2) and/or one high-voltage winding (3), the cooling circuit (7) being electrically insulated with respect to the low-voltage and high-voltage windings (2, 3), the cooling circuit (7) comprising at least one cooling duct (6) with a cooling fluid circulating inside the cooling duct (6),
the transformer (1) being characterized in that the cooling circuit (7) is provided with a constructive arrangement configured not to form a turn around the core column (1.2, 1.3).

2. A transformer according to claim 1 , characterized in that the cooling circuit (7) comprises at least one cooling duct (6) partly involving the low-voltage winding (2) and/or the high-voltage winding (3).

3. A transformer according to claim 1 , characterized in that the cooling circuit (7) comprises at least one cooling duct (6) partly involving the low-voltage winding and/or the high-voltage winding (3).

4. A transformer according to claim 2, characterized in that the cooling circuit (7) is provided with a plurality of cooling ducts (6) arranged in spaces comprised between the low-voltage winding (2) and the high-voltage winding (3) and/or spaces comprised between the core column (1.2, 1.3) and the low-voltage and high-voltage windings (2, 3).

5. A transformer according to claim 1, characterized in that the cooling fluid consists of seawater.

6. A transformer according to claim 2, characterized in that the cooling duct (6) is constituted by a metallic material.

7. A transformer according to claim 2, characterized in that the cooling duct (6) is constituted by a resin or fiberglass insulating material.

8. A transformer according to claim 1, characterized in that the cooling fluid circulates in a forced manner inside the cooling circuit (7).

9. A dry distribution transformer (1) comprising at least:
one low-voltage winding (2) and a high-voltage winding (3), con-centrically mounded around a core column (1.2, 1.3); and
a cooling circuit (7) associated to at least one low-voltage winding (2) and/or a high-voltage winding (3), the cooling circuit (7) comprising at least one cooling duct (6) with a cooling fluid circulating inside the cooling duct (6),
the transformer (1) being characterized in that the cooling circuit (7) is provides with a constructive arrangement configured not to form a turn around the core column (1.2, 1.3).

10. A dry distribution transformer (1) comprising at least:
one low-voltage winding (2) and a high-voltage winding (3), concentrically mounded around a core column (1.2, 1.3); and
one cooling circuit (7) associated to at least one low-voltage winding (2) and/or one high-voltage winding (3), the cooling circuit (7) comprising at least one cooling duct (6) with a cooling fluid circulating inside the cooling duct (6),
the transformer (1) being characterized in that the cooling circuit (7) is provided with cooling ducts (6), wherein the cooling duct (6) has a cross section configured not to form a turn around the core column (1.2, 1.3).
